(19) United States
(12) Patent Application Publication
(10) Pub. No.: US 2026/0329604 A1
(43) Pub. Date: Oct. 22, 2026

(54) METHOD FOR INTERACTION, PROCESSING AND CONTROLLING OF APPLICATION SERVICE IN CLOUD DESKTOP

(71) Applicant: HANGZHOU ALICLOUD PEITIAN INFORMATION TECHNOLOGY CO., LTD., Singapore (SG)

(72) Inventors: Yun PIAO, Hangzhou, Zhejiang (CN); Xiadlu TONG, Shanghai (CN); Lei WANG, Hangzhou, Zhejiang (CN); Qinghe XU, Shanghai (CN)

(21) Appl. No.: 19/114,672

(22) PCT Filed: Sep. 21, 2023
(86) PCT No.: PCT/CN2023/120294

§ 371 Date: Mar. 24, 2025

(30) Foreign Application Priority Data
Sep. 23, 2022 (CN) 202211170636.1

(51) Int. Cl. G06F 9/451; G06F 3/04817; H04L 67/025

(52) U.S. Cl. CPC G06F 9/452; G06F 3/04817; H04L 67/025

(57) ABSTRACT

The present application discloses a method for interaction, processing, and controlling of an application service in a cloud desktop, and the interaction method includes: determining, by an application control service deployed in a client based on a connection relationship established between the client and a cloud desktop server and in response to triggering the application service in the cloud desktop in the client, whether the application service is a cloud application; if the application service is a cloud application, sending, by the application control service, a start request for the cloud application to a cloud application server; sending, by the cloud application server according to the start request, application streaming data generated after streaming processing of the cloud application to the application control service; and outputting, by the client according to the application streaming data received in the application control service, the cloud application into the cloud desktop.

### CROSS-REFERENCE TO RELATED APPLICATIONS

The present application is a National Stage of International Application No. PCT/CN2023/120294, filed on Sep. 21, 2023, which claims priority to Chinese Patent Application No. 202211170636.1, entitled “METHOD FOR INTERACTION, PROCESSING AND CONTROLLING OF APPLICATION SERVICE IN CLOUD DESKTOP” and filed with the China National Intellectual Property Administration on Sep. 23, 2022. These applications are hereby incorporated by reference in their entireties.

### TECHNICAL FIELD

The present application relates to the field of computer application technologies and, in particular, to a method and an apparatus for interaction of an application service in a cloud desktop, a method and an apparatus for processing data of an application service in a cloud desktop, a method and an apparatus for controlling an application service in a cloud desktop, and an interactive control system for an application service in a cloud desktop. The present application also relates to a computer storage medium and an electronic device.

### BACKGROUND

Cloud desktop technologies may be generated based on factors such as the complexity of computer operation and maintenance, the demand for high-performance computers, data storage security, and office environment limitations. For example, if an office computer has poor configuration and insufficient performance, and it is too troublesome to replace the hardware, improvement of the performance may be achieved through a cloud desktop; when one works at home or is on a business trip, enterprise intranet resources cannot be accessed via an external network, the cloud desktop may be chosen to achieve secure access and so on.

The cloud desktop technology may be called cloud computer, and is an overall service solution including cloud resources, transmission protocols and cloud terminals. With open cloud terminals through transmission protocols, users are provided with desktop, application, hardware and other resources in an on-demand service and elastic allocation service mode. Single-machine for multi-user may be achieved in a case that users do not need to consider building a complex IT (Information technology) environment.

### SUMMARY

The present application provides a method for interaction of an application service in a cloud desktop, to solve the problem in the prior art that the resource overhead and performance loss caused by starting a cloud application in a cloud desktop are large.

The present application provides a method for interaction of an application service in a cloud desktop, including:
determining, by an application control service deployed in a client based on a connection relationship established between the client and a cloud desktop server and in response to triggering the application service in the cloud desktop in the client, whether the application service is a cloud application;
if the application service is a cloud application, sending, by the application control service, a start request for the cloud application to a cloud application server;
sending, by the cloud application server according to the start request, application streaming data generated after streaming processing of the cloud application to the application control service; and
outputting, by the client according to the application streaming data received in the application control service, the cloud application into the cloud desktop.

In some embodiments, the method further includes:
determining, by the application control service when determining that the application service is a local application of the cloud desktop or a local application of the client, whether there is a started cloud application in the cloud desktop;
if there is a started cloud application in the cloud desktop, sending, by the application control service, a streaming request for the started cloud application to the cloud application server;
sending, by the cloud application server according to the streaming request, application streaming data generated after streaming processing of the started cloud application to the cloud desktop server;
performing, by the cloud desktop server according to the application streaming data for the started cloud application, display processing for a picture of the started cloud application in the cloud desktop.

In some embodiments, the performing, by the cloud desktop server according to the application streaming data for the started cloud application, display processing for the picture of the started cloud application in the cloud desktop includes:
placing, by the cloud desktop server according to the application streaming data for the started cloud application, the picture of the started cloud application in the cloud desktop to a lower layer to the local application of the cloud desktop or the local application of the client; or placing the picture of the started cloud application in a form of an icon into a status bar of the cloud desktop.

The present application further provides a method for processing data of an application service in a cloud desktop, performed by an application control service deployed in a client including:
determining, based on a connection relationship established between the client and a cloud desktop server and in response to triggering the application service in the cloud desktop in the client, whether the application service is a cloud application;
if the application service is a cloud application, sending a start request for the cloud application to a cloud application server, where the start request includes a streaming processing instruction and streaming data routing information;
receiving application streaming data generated according to the streaming processing instruction and sent in response to the streaming data routing information in the start request.

In some embodiments, the method further includes:
determining whether there is a started cloud application in the cloud desktop, when it is determined that the application service is a local application of the cloud desktop or a local application of the client;
if there is a started cloud application in the cloud desktop, sending a streaming request for the started cloud application to the cloud application server, where the streaming request includes streaming processing instruction information and streaming data routing information.

The present application further provides a method for controlling an application service in a cloud desktop, performed by a cloud application server, including:
receiving a start request for a to-be-started cloud application or a streaming request for a started cloud application; where the start request includes a streaming processing instruction and streaming routing information for the to-be-started cloud application, and the streaming request includes a streaming processing instruction and streaming routing information for the started cloud application;
performing, according to the streaming processing instruction in the start request, streaming processing for the to-be-started cloud application to generate application streaming data for the to-be-started cloud application; or, performing, according to the streaming processing instruction in the streaming request, streaming processing for the started cloud application to generate application streaming data for the started cloud application;
sending, according to a routing path specified through the streaming routing information in the start request, the application streaming data for the to-be-started cloud application; or, sending, according to a routing path specified through the streaming routing information in the streaming request, the application streaming data for the started cloud application.

In some embodiments, the sending, according to the routing path specified through the streaming routing information in the start request, the application streaming data includes:
sending, according to the routing path specified through the streaming routing information in the start request, the application streaming data for the to-be-started cloud application to an application control service deployed in the client.

In some embodiments, the sending, according to the routing path specified through the streaming routing information in the streaming request, the application streaming data includes:
sending, according to the routing path specified through the streaming routing information in the streaming request, the application streaming data for the started cloud application to a cloud desktop server.

The present application further provides an interactive control system for an application service in a cloud desktop, including: a client, a cloud desktop server, and a cloud application server;
an application control service-deployed in the client determines, based on a first connection relationship established between the client and the cloud desktop server and in response to triggering the application service in the cloud desktop in the client, whether the application service is a cloud application; if the application service is a cloud application, establishes, according to received cloud application information sent by the cloud desktop server, a second connection relationship with the cloud application server, and sends, based on the second connection relationship, a start request for the cloud application to the cloud application server, where the start request includes a streaming processing instruction and streaming data routing information; receives application streaming data that is sent in response to the streaming data routing information in the start request and generated according to the streaming processing instruction; sends the application streaming data to a displaying-side of the client;
the cloud application server sends, according to the streaming data routing information in the start request, the application streaming data generated according to the streaming processing instruction to the application control service;
the displaying-side of the client outputs the cloud application according to the received application streaming data.

In some embodiments, where,
the application control service determines whether there is a started cloud application in the cloud desktop when determining that the application service is a local application of the cloud desktop or a local application of the client, and sends, if there is a started cloud application in the cloud desktop, a streaming request for the started cloud application to the cloud application server, where the streaming request includes streaming processing instruction information and streaming data routing information;
the cloud application server performs, according to the streaming processing instruction information in the streaming request, streaming processing on the started cloud application to generate streaming data, and sends, according to the streaming data routing information in the streaming request, the streaming data to the cloud desktop server;
the cloud desktop server outputs the started cloud application onto the cloud desktop according to the streaming data.

In some embodiments, where,
the cloud desktop server places, according to the streaming data, a picture of the cloud application in the cloud desktop to a lower layer to the cloud's own application or the local application of the client; or places the picture of the cloud application in a form of an icon into a status bar of the cloud desktop.

The present application further provides a computer storage medium for storing data generated by a network platform, and a corresponding program for processing the data generated by the network platform;
when the program is read and executed by a processor, the method for interaction of the application service in the cloud desktop as described above, or the method for processing the data of the application service in the cloud desktop as described above, or the method for controlling the application service in the cloud desktop as described above is executed.

The present application further provides an electronic device, including:
a processor;
a memory for storing a program for processing data generated by a network platform; when the program is read and executed by the processor, the method for interaction of the application service in the cloud desktop as described above, or the method for processing the data of the application service in the cloud desktop as described above, or the method for controlling the application service in the cloud desktop as described above is executed.

Compared with the prior art, the present application has the advantages as follows.

The present application provides a method for interaction of an application service in a cloud desktop. On the one hand: the start request for the cloud application is sent to the cloud application server through the application control service, the cloud application server performs streaming processing and sends the generated application streaming data to the application control service in accordance with the routing path specified in the start request. Considering the application control service is deployed in the client-side, thus for access to the cloud application, streaming needs to be performed only once, so that display can be performed on the displaying-side of the client. It is no longer necessary to first stream the cloud application to the cloud desktop by the cloud application server and then stream it from the cloud desktop to the client, thereby reducing resource overhead. On the other hand: the started cloud application still being displayed on the cloud desktop can be ensured in a case of starting the client's local application or the cloud desktop's own application, and then in a case that switching is performed based on the cloud desktop, between the started cloud application, the started local application, and the started own application, or between the started cloud application and the started local application, or between the started cloud application and the started own application, the operation can be performed in a visible manner, thereby avoiding the problem of cumbersome user operation and poor user experience due to the fact that merely cloud applications can be displayed when a cloud application is used in the cloud desktop, or only local applications or the cloud desktop's own applications can be displayed during the displaying of the local application of the client or the cloud desktop's own application.

### BRIEF DESCRIPTION OF DRAWINGS

FIG. 1 is a flow chart of an embodiment of a method for interaction of an application service in a cloud desktop provided by the present application.

FIG. 2 is a schematic diagram of a scenario in which a triggered application service is a cloud application in an embodiment of a method for interaction of an application service in a cloud desktop provided by the present application.

FIG. 3 is a schematic diagram of a scenario in which a triggered application service is a local application of a cloud desktop or a local application of a client in an embodiment of a method for interaction of an application service in a cloud desktop provided by the present application.

FIG. 4 is a sequence diagram of an embodiment of a method for interaction of an application service in a cloud desktop provided by the present application.

FIG. 5 is a schematic structural diagram of an embodiment of an apparatus for interaction of an application service in a cloud desktop provided by the present application.

FIG. 6 is a flow chart of an embodiment of a method for processing data of an application service in a cloud desktop provided by the present application.

FIG. 7 is a schematic structural diagram of an embodiment of an apparatus for processing data of an application service in a cloud desktop provided by the present application.

FIG. 8 is a flow chart of an embodiment of a method for controlling an application service in a cloud desktop provided by the present application.

FIG. 9 is a schematic structural diagram of an embodiment of an apparatus for controlling an application service in a cloud desktop provided by the present application.

FIG. 10 is a schematic structural diagram of an embodiment of an interactive control system for an application service in a cloud desktop provided by the present application.

FIG. 11 is a schematic structural diagram of an embodiment of an electronic device provided by the present application.

### DESCRIPTION OF EMBODIMENTS

In the following description, numerous specific details are set forth in order to provide a thorough understanding of the present application. Still, the present application can be implemented in many other ways different from those described herein, and those skilled in the art can make similar extensions without violating the connotation of the present application. Therefore, the present application is not limited to the specific implementations disclosed below.

The terms used in the present application are merely intended for describing particular embodiments and are not intended to be limiting of the present application. The descriptions used in the present application and the appended claims, such as “a”, “first”, and “second”, etc., are not limitations on quantity or sequence, but are used to distinguish the same type of information from each other.

Based on the introduction of the cloud desktop in the background, it can be known that the cloud desktop can be an open cloud terminal, which provides, through transmission protocols, desktop, application, hardware and other resources for users in an on-demand service and elastic allocation service mode, so that users do not need to build a computer application environment. The existing mainstream cloud desktop services support starting applications within the cloud desktop by default. However, when there is a need to open within the cloud desktop a cloud application provided by a cloud application server, in order to achieve the starting of the cloud application, the cloud application must be streamed first from the cloud application server to the cloud desktop, and then streamed from the cloud desktop to the user-end. The problem with this method for starting the cloud application is that after the stream of the cloud application is received in the cloud desktop, it needs to be decoded, rendered, and then re-encoded and streamed to the user-end, thus the process may generate twice streaming processing, which may cause a lot of resource overhead and performance loss.

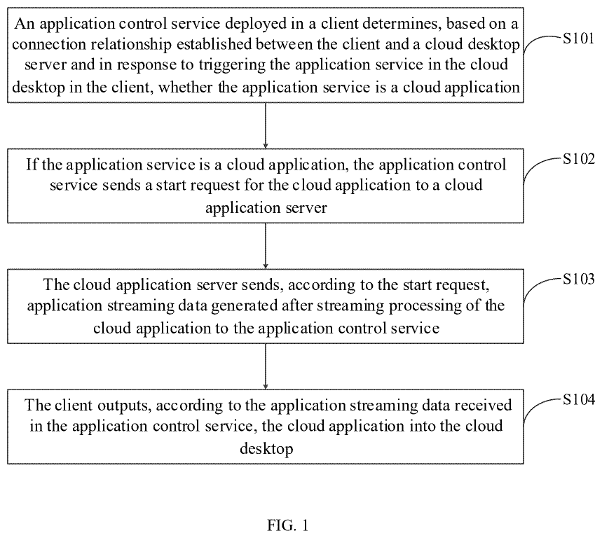

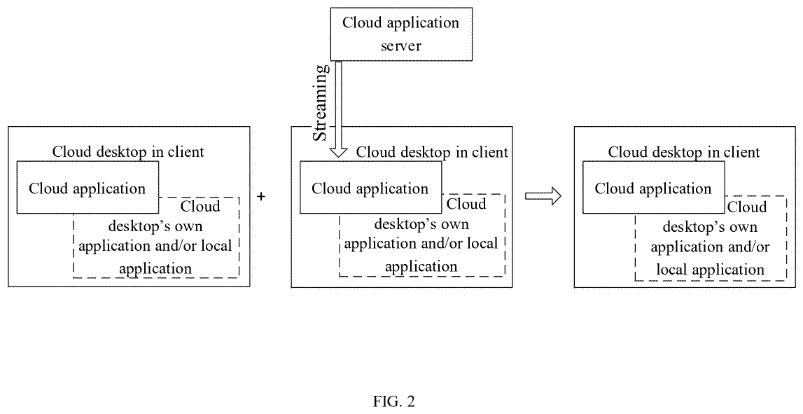

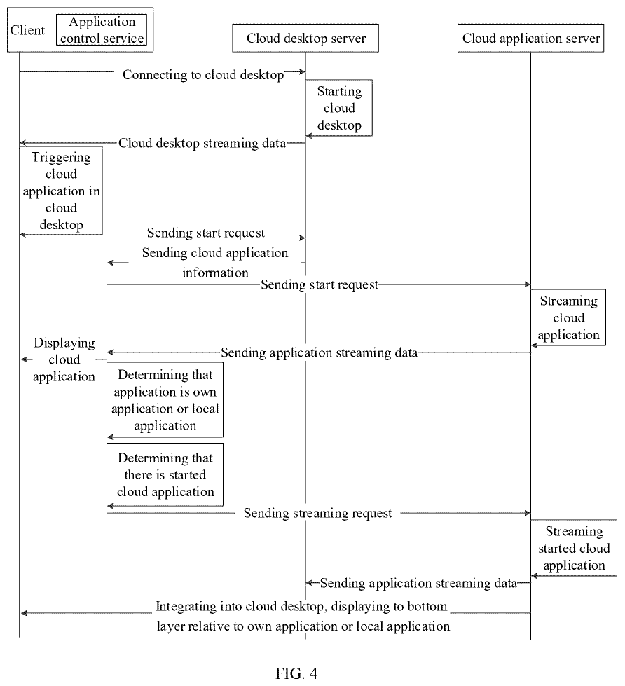

In view of this, the present application provides a method for interaction of an application service in a cloud desktop, as shown in FIG. 1, FIG. 2 and FIG. 4. FIG. 1 is a flow chart of an embodiment of a method for interaction of an application service in a cloud desktop provided by the present application; FIG. 2 is a schematic diagram of a scenario in which a triggered application service is a cloud application in an embodiment of a method for interaction of an application service in a cloud desktop provided by the present application; and FIG. 4 is a sequence diagram of an embodiment of a method for interaction of an application service in a cloud desktop provided by the present application. The interaction method embodiment includes:
step S101: an application control service deployed in a client determines, based on a connection relationship established between the client and a cloud desktop server and in response to triggering the application service in the cloud desktop in the client, whether the application service is a cloud application;
step S102: if the application service is a cloud application, the application control service sends a start request for the cloud application to a cloud application server;
step S103: the cloud application server sends, according to the start request, application streaming data generated after streaming processing of the cloud application to the application control service; and
step S104: the client outputs, according to the application streaming data received in the application control service, the cloud application into the cloud desktop.

Step S101 is intended to determine whether the triggering of the application service in the cloud desktop is for a cloud application.

Before describing the steps mentioned above in detail, the technical terms mentioned in the present application are explained first.

The cloud application may be understood as a technology for deploying application services in a cloud virtualization environment, that is, application virtualization technology. It is a remote application technology by which a picture in the cloud is transmitted into a cloud desktop of a client through a stream, allowing the client to operate as if using a local application of the client. That is, the cloud application can provide a service of the cloud application for the cloud desktop through the cloud application server.

The client is a user operating-end side, which can be understood as the end side that can operate, through the cloud desktop, at least one application service of a local application or the cloud application in the cloud desktop, or of course can also operate, through a desktop of the client, the local application of the client. That is, the client can operate the local application in the cloud desktop and the cloud application in the cloud desktop through the installed cloud desktop, and can operate the local application of the client outside the cloud desktop.

The cloud desktop server provides, through a transmission protocol, the local application in the cloud desktop and/or the cloud application requested through the cloud application server, for the client in the cloud desktop manner.

The cloud desktop is an operating desktop virtualized to the client, can also be called a cloud computer, and is an overall service mode, including cloud resources, transmission protocols and cloud terminals, and provides, through open cloud terminals, for users with desktops, applications, hardware and other resources in an on-demand service and elastic allocation service mode, and therefore a service of single-machine for multi-user can be achieved without a need for building a complex IT environment.

In this embodiment, the application control service is deployed in the client, and whether the triggered application service is a cloud application is determined through the application control service. A connection relationship needs to be established between the client and the cloud desktop server, that is, the cloud desktop being running on the client, specifically, the case can be that the client sends the request to start the cloud desktop to the cloud desktop server, and the cloud desktop server performs streaming processing for the cloud desktop according to the request to start the cloud desktop, to generate cloud desktop streaming data and sends it to the client, and then the cloud desktop is displayed on a displaying-side of the client. An access request is generated based on the triggering operation on the application service in the cloud desktop displayed by the client, and the application control service deployed in the client determines whether the triggered application service in the access request is a cloud application, the specific determination manner of which can be determination according to identification information of the application service or an output transmission channel, etc. In this implementation, the method that can be adopted is to determine through an entry for starting the cloud application, for example, whether the starting entry is an entry of the cloud application in the cloud desktop of the client. Of course, how to determine whether the started application is a cloud application is not limited to the above content. It should be noted that whether the application service is a cloud application can be determined through the cloud desktop server or through the application control service deployed in the client.

In step S102, when it is determined in step S101 that the triggered application service is the cloud application, the application control service may send a start request for the cloud application to the cloud application server, since running the cloud application on the cloud desktop requires obtaining the streaming data of the cloud application from the cloud application server and then sending the start request to the cloud application server.

The purpose of step S103 is to generate and send the streaming data of the cloud application. After receiving the start request, the cloud application server performs streaming processing on the cloud application according to streaming instruction information included in the start request, to generate corresponding streaming data, and sends the streaming data to the application control service of the client according to a routing address specified in streaming routing information included in the start request. The cloud application server can perform, according to relevant information of the cloud application in the received start request, calculations, real-time encoding and streaming after encoding, to send the streaming data to the application control service side through a network.

The purpose of step S104 is to display a picture of the cloud application on the cloud desktop of the client. Specifically, the application control service sends the received application streaming data to a displaying-side of the client, and the displaying-side can perform decoding, rendering and other processing according to the application streaming data, and then display the picture of the cloud application on the displaying-side.

In this embodiment, the application control service sends the start request for the cloud application to the cloud application server, and the cloud application server performs streaming processing and sends the generated application streaming data to the application control service of the client in accordance with the specified routing path. Since the application control service is deployed in the client side, for access to the cloud application, streaming needs to be performed only once, so that display can be performed on the displaying-side of the client. Therefore, it is no longer necessary to first stream the cloud application to the cloud desktop by the cloud application server and then stream it from the cloud desktop to the client, thereby reducing resource overhead.

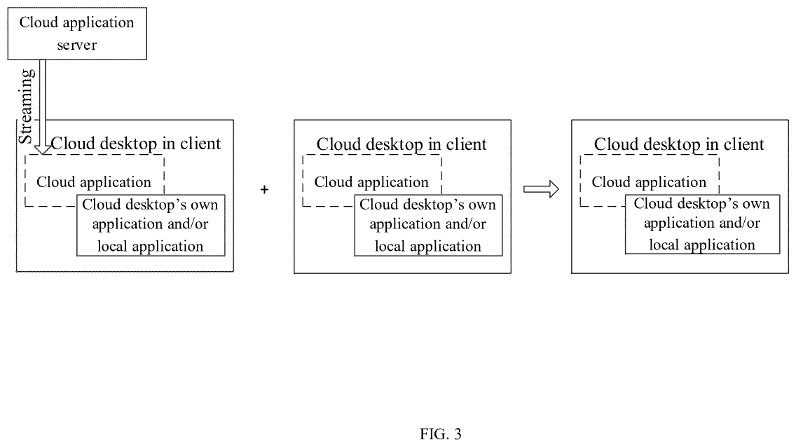

As shown in FIG. 3 and FIG. 4, FIG. 3 is a schematic diagram of a scenario in which a triggered application service is a local application of a cloud desktop or a local application of a client in an embodiment of a method for interaction of an application service in a cloud desktop provided by the present application. To improve the convenience of the interactive operation based on the cloud desktop, based on the above, this embodiment can further include:
step S105: the application control service determines, when determining that the application service is a local application of the cloud desktop or a local application of the client, whether there is a started cloud application in the cloud desktop; specifically, when the application control service determines that the application service is not a cloud application, streaming processing does not need to be performed for the application service by the cloud application server. However, considering the convenience for users to operate based on the application service in the cloud desktop, determination needs to further made in terms of whether there is a started cloud application in the cloud desktop. In this embodiment, the local application of the cloud desktop can be understood as an application service provided by the cloud desktop server. The cloud application is a cloud application service requested through the application control service deployed in the client to the cloud application server.

Step S106: if there is a started cloud application in the cloud desktop, the application control service sends a streaming request for the started cloud application to the cloud application server. In order to ensure that users can still learn about the started cloud application when accessing other types of applications, for example, the local application of the client or cloud desktop's own application, other than cloud applications and/or perform convenient switching between various types of applications, in step S106, the streaming request for the started cloud application needs to be sent to the cloud application server.

Step S107: the cloud application server sends, according to the streaming request, application streaming data generated after streaming processing of the started cloud application to the cloud desktop server, where the streaming request can include streaming processing instruction information and streaming data routing information. In this embodiment, the streaming data routing information includes information for specifying routing the application streaming data to the cloud desktop server. It can be understood that when the started cloud application undergoes dynamic real-time changes, the streaming processing instruction information can include streaming frequency, and the cloud application server can perform streaming processing for the cloud application according to the streaming frequency, to generate application streaming data in real time, thereby reducing bandwidth requirements and computing resource overhead. When the cloud application does not undergo dynamic real-time changes, the picture of the cloud application is static, and thus streaming processing may not occupy a large amount of resources. Of course, even for dynamically changing pictures, the overhead of streaming resources can still be controlled by the streaming frequency.

Step S108: the cloud desktop server performs, according to the application streaming data, display processing for a picture of the started cloud application in the cloud desktop. Specifically, the cloud desktop server places, according to the streaming data, the picture of the started cloud application in the cloud desktop to a lower layer to the cloud desktop's own application or the local application of the client; or places the picture of the started cloud application in a form of an icon into a status bar of the cloud desktop. That is to say, the started cloud application is in a suspended state based on a situation where other applications are started. In the suspended state, the started cloud application can still be displayed on the cloud desktop, where the display mode is not limited to placing the picture of the started cloud application to a bottom layer for displaying the current cloud desktop application service or minimizing the picture of the started cloud application to be into a status bar or taskbar, or any manner in which displaying is performed in the cloud desktop in a visible way, to facilitate users to switch between a plurality of application services.

Step S107 and step S108 can ensure that the started cloud application can still be displayed in the cloud desktop in a case of starting the local application of the client or the cloud desktop's own application, and then in a case that switching is performed based on the cloud desktop between the started cloud application, the started local application, and the started own application, or between the started cloud application and the started local application, or between the started cloud application and the started own application, the operation can be performed in a visible manner, thereby avoiding the problem of cumbersome user operation due to the fact that merely cloud applications can be displayed when a cloud application is used in the cloud desktop, or only local applications or the cloud desktop's own applications can be displayed during displaying of the local application of the client or cloud desktop's own application.

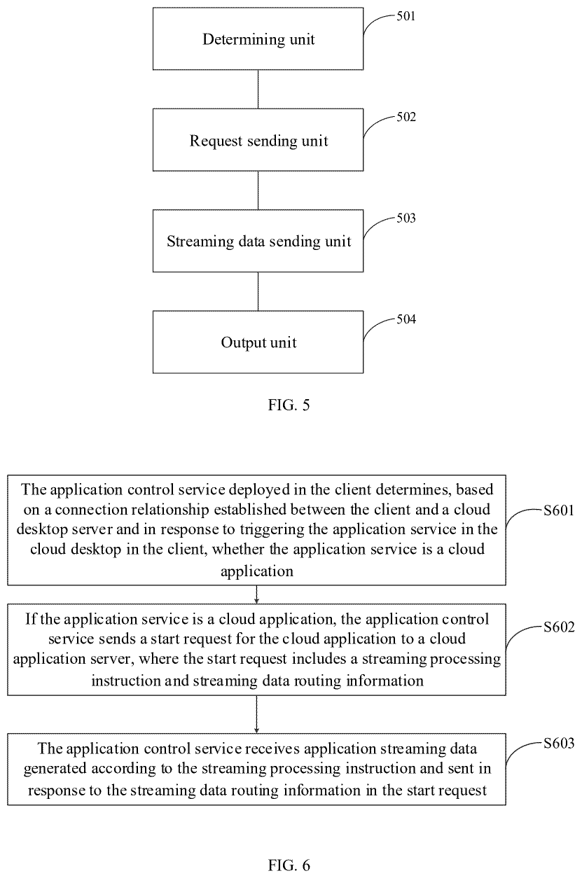

The above is a description of an embodiment of the method for interaction of the application service in the cloud desktop provided by the present application, which is made from the multiple perspectives of a client, a cloud desktop server, a cloud application server, and so on. Corresponding to the embodiment of the method for the interaction of the application service in the cloud desktop, the present application further discloses an embodiment of an apparatus for interaction of an application service in a cloud desktop, please refer to FIG. 5. Since the apparatus embodiment is basically similar to the method embodiment, the description is relatively simple, and for the relevant parts, reference can be made to the partial description of the method embodiment. The apparatus embodiment described below is merely illustrative.

As shown in FIG. 5, which is a schematic structural diagram of an embodiment of an apparatus for interaction of an application service in a cloud desktop provided by the present application. The apparatus embodiment can include a determining unit 501, a request sending unit 502, a streaming data sending unit 503, and an output unit 504, where,
the determining unit 501 is configured to: determine, based on a connection relationship established between a client and a cloud desktop server and in response to triggering the application service in the cloud desktop in the client, whether the application service is a cloud application; for the specific content, reference can be made to the description of step S101 mentioned above, which will not be elaborated here;
the request sending unit 502 is configured to: send when a determination result in the determining unit 501 is yes, a start request for the cloud application to the streaming data sending unit 503; for the specific content, reference can be made to the description of step S102 mentioned above, which will not be elaborated here;
the streaming data sending unit 503 is configured to: send according to the received start request sent by the request sending unit 502, application streaming data generated after streaming processing of the cloud application to the output unit 504; for the specific content, reference can be made to the description of step S103 mentioned above, which will not be elaborated here;
the output unit 504 is configured to output the cloud application into the cloud desktop according to the received application streaming data sent by the streaming data sending unit. For the specific content, reference can be made to the description of step S104 mentioned above, which will not be elaborated here.

In an implementation, the apparatus may further include: a start determining unit, a streaming request unit, a streaming sending unit, and a display processing unit. To improve the convenience of interactive operations based on the cloud desktop, based on the above, when the determining unit 501 determines that the application service is not a cloud application, the apparatus may be configured to perform operations with the mentioned-above units as the following:
the start determining unit is configured to: determine, when the determining unit 501 determines that the application service is a local application of the cloud desktop or a local application of the client, whether there is a started cloud application in the cloud desktop; for the specific content, reference can be made to the description of step S105 mentioned above;
the streaming request unit is configured to: send, according to a determination that a determining result of the start determining unit is positive, a streaming request for the started cloud application to the streaming sending unit; for the specific content, reference can be made to the description of step S106 mentioned above;
the streaming sending unit is configured to send, according to the streaming request, application streaming data generated after streaming processing of the started cloud application to the display processing unit; for the specific content, reference can be made to the description of step S107 mentioned above;
the display processing unit is configured to perform, according to the application streaming data, display processing for a picture of the started cloud application in the cloud desktop. Specifically, the display processing unit can place, according to the streaming data, the picture of the started cloud application in the cloud desktop to a lower layer to the cloud desktop's own application or the local application of the client; or place the picture of the started cloud application in a form of an icon into a status bar of the cloud desktop; for the specific content, reference can be made to the description of step S108 mentioned above.

The above is a description of the embodiment of the apparatus for the interaction of the application service in the cloud desktop provided by the present application. The description of the embodiment of the apparatus is relatively brief. The specific content can be found in the mentioned-above method embodiment and understood through subsequent content.

Based on the content above, the present application further provides a method for processing data of an application service in a cloud desktop, as shown in FIG. 6, which is a flow chart of an embodiment of a method for processing data of an application service in a cloud desktop provided by the present application. The description of the embodiment of the processing method is mainly from a perspective of an application control service deployed in a client. The embodiment can include:
step S601: the application control service deployed in the client determines, based on a connection relationship established between the client and a cloud desktop server and in response to triggering the application service in the cloud desktop in the client, whether the application service is a cloud application;
step S602: if the application service is a cloud application, the application control service sends a start request for the cloud application to a cloud application server, where the start request includes a streaming processing instruction and streaming data routing information;
step S603: the application control service receives application streaming data generated according to the streaming processing instruction and sent in response to the streaming data routing information in the start request. The displaying-side of the client can decode and render according to the application streaming data, to display the picture of the cloud application.

In this embodiment, the application control service sends the start request for the cloud application to the cloud application server, and receives the application streaming data sent by the cloud application server according to the specified routing path, where the specified routing path is the content included in the start request. In this embodiment, the specified routing path is a path for routing to the application control service. Since the application control service is deployed in the client, for the accessed cloud application, streaming needs to be performed only once, so that displaying can be performed on the displaying-side of the client. It is no longer necessary to first stream the cloud application to the cloud desktop by the cloud application server and then stream it from the cloud desktop to the client, thereby reducing resource overhead, and improving the performance of the cloud desktop.

Based on the content above, in order to improve the convenience of the interactive operations based on the cloud desktop, the method can further include:
step S604: the application control service determines whether there is a started cloud application in the cloud desktop when determining that the application service is a local application of the cloud desktop or a local application of the client;
step S605: if there is a started cloud application in the cloud desktop, the application control service sends a streaming request for the started cloud application to the cloud application server, where the streaming request includes streaming processing instruction information and streaming data routing information. Likewise, the streaming processing instruction information may include streaming frequency.

For the contents of the above steps S601 to S605, reference may be made to the description of the application control service deployed in the client in the embodiment of the method for the interaction of the application service in the cloud desktop provided by the present application, which will not be repeated here.

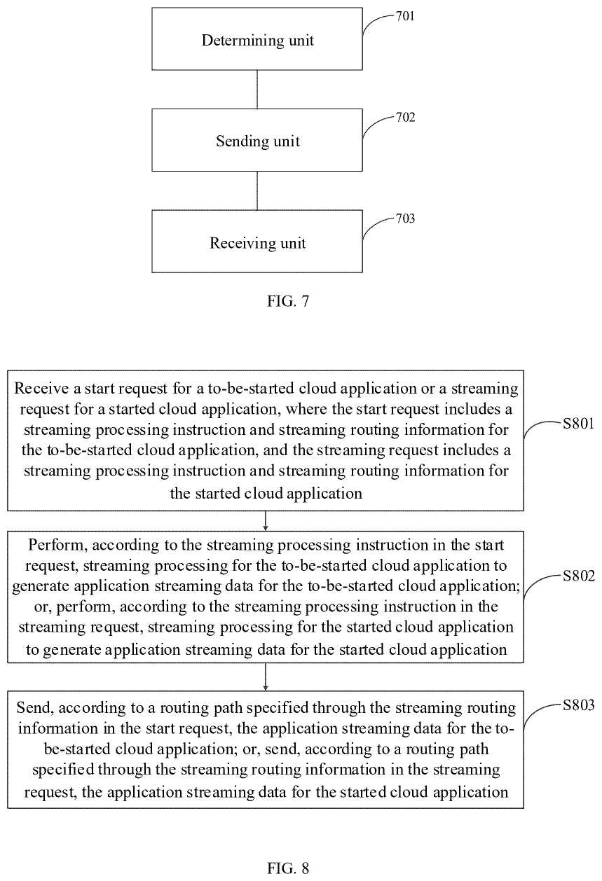

The above is a description, which is made in terms of a client, of an embodiment of a method for processing data of an application service in a cloud desktop provided by the present application. Corresponding to the embodiment of the method for processing the data of the application service in the cloud desktop, the present application further discloses an embodiment of an apparatus for processing data of an application service in a cloud desktop, please refer to FIG. 7. Since the apparatus embodiment is basically similar to the method embodiment, the description is relatively simple, and for the relevant parts, reference can be made to the partial description of the method embodiment. The apparatus embodiment described below is merely illustrative.

As shown in FIG. 7, which is a schematic structural diagram of an embodiment of an apparatus for processing data of an application service in a cloud desktop provided by the present application. The processing apparatus embodiment can include:
a determining unit 701, configured to determine, based on a connection relationship established between the client and a cloud desktop server and in response to triggering the application service in the cloud desktop in the client, whether the application service is a cloud application;
a sending unit 702, configured to send, when a determination result in the determining unit is positive, a start request for the cloud application to a cloud application server, where the start request includes a streaming processing instruction and streaming data routing information;
a receiving unit 703, configured to receive application streaming data generated according to the streaming processing instruction and sent in response to the streaming data routing information in the start request of the sending unit.

Based on the content above, in order to improve the convenience of the interactive operations based on the cloud desktop, the apparatus can further include:
a start determining unit, configured to determine whether there is a started cloud application in the cloud desktop when determining that the application service is a local application of the cloud desktop or a local application of the client;
a streaming request sending unit, configured to send, when a determination result of the start determining unit is positive, a streaming request for the started cloud application to the cloud application server, where the streaming request includes streaming processing instruction information and streaming data routing information.

The above is a brief description of the embodiment of the apparatus for processing the data of the application service in the cloud desktop provided by the present application. For specific contents of the processing apparatus embodiment, reference can be made to the embodiment of the method for processing the data of the application service in the cloud desktop, as well as the relevant contents of the embodiment of the method for the interaction of the application service in the cloud desktop.

Based on the content above, the present application further provides a method for controlling an application service in a cloud desktop, as shown in FIG. 8, which is a flow chart of an embodiment of a method for controlling an application service in a cloud desktop provided by the present application. The embodiment of the controlling method is mainly described from the perspective of a cloud application server, and the method can specifically include:
step S801: receive a start request for a to-be-started cloud application or a streaming request for a started cloud application; where the start request includes a streaming processing instruction and streaming routing information for the to-be-started cloud application, and the streaming request includes a streaming processing instruction and streaming routing information for the started cloud application;
step S802: perform, according to the streaming processing instruction in the start request, streaming processing for the to-be-started cloud application to generate application streaming data for the to-be-started cloud application; or, perform, according to the streaming processing instruction in the streaming request, streaming processing for the started cloud application to generate application streaming data for the started cloud application;
step S803: send, according to a routing path specified through the streaming routing information in the start request, the application streaming data for the to-be-started cloud application; or, send, according to a routing path specified through the streaming routing information in the streaming request, the application streaming data for the started cloud application.

Regarding the step S803 of sending, according to the routing path specified through the streaming routing information in the start request, the application streaming data for the to-be-started cloud application, the method can include:
sending, according to the routing path specified through the streaming routing information in the start request, the application streaming data for the to-be-started cloud application to an application control service-side deployed in the client.

Regarding the step S803 of sending, according to the routing path specified through the streaming routing information in the streaming request, the application streaming data for the started cloud application, the method can include:
sending, according to the routing path specified through the streaming routing information in the streaming request, the application streaming data for the started cloud application to a cloud desktop server.

In the embodiment, the cloud application server can send, according to different routing information, the application streaming data generated for the cloud application to a designated location, that is, route the started cloud application to the cloud desktop, thereby ensuring that the started cloud application can be displayed in the cloud desktop. Of course, the displaying manner in the cloud desktop can be displaying in the form of a window to a lower layer to the currently activated application (the cloud desktop's own application and/or the client's local application), or displaying in the form of an icon into the status bar or task bar, etc., which can be any way satisfying displaying the started cloud application in the cloud desktop of the client. This can reduce the resource overhead of streaming processing when the cloud application server performs streaming processing, thereby improving the performance of the cloud desktop.

For the contents of the steps S801 to S803, reference may be made to the relevant contents in the embodiment of the method for the interaction of the application service in the cloud desktop, which will not be elaborated here.

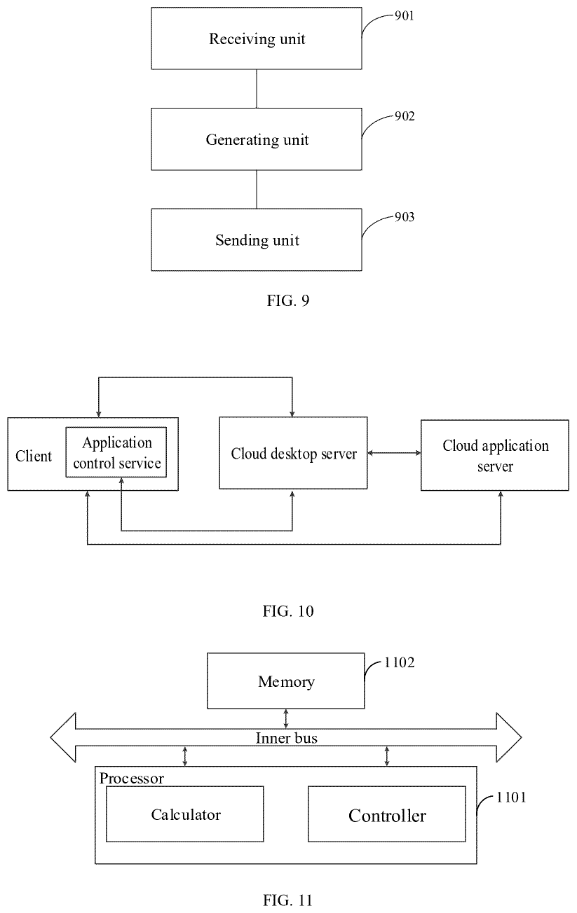

Based on the above, the present application further provides an embodiment of an apparatus for controlling an application service in a cloud desktop, corresponding to the embodiment of the method for controlling the application service in the cloud desktop. The reference can be made to FIG. 9. Since the apparatus embodiment is basically similar to the method embodiment, the description is relatively simple, and for the relevant matters, reference can be made to the partial description of the method embodiment. The apparatus embodiment described below is merely illustrative.

As shown in FIG. 9, which is a schematic structural diagram of an embodiment of an apparatus for controlling an application service in a cloud desktop provided by the present application. The control apparatus embodiment can include:
a receiving unit 901, configured to: receive a start request for a to-be-started cloud application or a streaming request for a started cloud application; where the start request includes a streaming processing instruction and streaming routing information for the to-be-started cloud application, and the streaming request includes a streaming processing instruction and streaming routing information for the started cloud application;
a generating unit 902, configured to: perform, according to the streaming processing instruction in the start request, streaming processing for the to-be-started cloud application to generate application streaming data for the to-be-started cloud application; or, perform, according to the streaming processing instruction in the streaming request, streaming processing for the started cloud application to generate application streaming data for the started cloud application;
a sending unit 903, configured to: send, according to a routing path specified through the streaming routing information in the start request, the application streaming data for the to-be-started cloud application; or, send, according to a routing path specified through the streaming routing information in the streaming request, the application streaming data for the started cloud application.

The sending unit 903 can be specifically configured to: send, according to the routing path specified through the streaming routing information in the start request, the application streaming data for the to-be-started cloud application to an application control service-side deployed in the client; or send, according to the routing path specified through the streaming routing information in the streaming request, the application streaming data for the started cloud application to a cloud desktop server.

For details of the embodiment of the apparatus for controlling the application service in the cloud desktop, reference can be made to the related contents of the embodiment of the method for controlling the application service in the cloud desktop and the related contents of the embodiment of the method for the interaction of the application service in the cloud desktop, which will not be elaborated here.

Based on the above content, the present application further provides an interactive control system for an application service in a cloud desktop, as shown in FIG. 10, which is a schematic structural diagram of an embodiment of an interactive control system for an application service in a cloud desktop provided by the present application. The interactive control system embodiment can include: a client, a cloud desktop server and a cloud application server;
an application control service-side deployed in the client determines, based on a first connection relationship established between the client and the cloud desktop server and in response to triggering the application service in the cloud desktop in the client, whether the application service is a cloud application; if the application service is a cloud application, the application control service-side establishes, according to received cloud application information sent by the cloud desktop server, a second connection relationship with the cloud application server, and sends, based on the second connection relationship, a start request for the cloud application to the cloud application server, where the start request includes a streaming processing instruction and streaming data routing information, receives application streaming data that is sent in response to the streaming data routing information in the start request and generated according to the streaming processing instruction; and sends the application streaming data to a displaying-side of the client;
the cloud application server sends, according to the streaming data routing information in the start request, the application streaming data generated according to the streaming processing instruction to the application control service-side;
the displaying-side of the client outputs the cloud application according to the received application streaming data.

Furthermore, in an implementation,
the application control service-side determines whether there is a started cloud application in the cloud desktop when determining that the application service is a local application of the cloud desktop or a local application of the client; the application control service-side sends, if there is a started cloud application in the cloud desktop, a streaming request for the started cloud application to the cloud application server, where the streaming request includes streaming processing instruction information and streaming data routing information;
the cloud application server performs, according to the streaming processing instruction information in the streaming request, streaming processing on the started cloud application to generate streaming data, and sends, according to the streaming data routing information in the streaming request, the streaming data to the cloud desktop server;
the cloud desktop server outputs the started cloud application onto the cloud desktop according to the streaming data. Specifically, the cloud desktop server places, according to the streaming data, a picture of the cloud application in the cloud desktop to a lower layer to the cloud desktop's own application or the local application of the client; or places the picture of the cloud application in a form of an icon into a status bar of the cloud desktop.

For the contents of the interactive control system embodiment, the reference can be made to the description of the embodiment of the method for the interaction of the application service in the cloud desktop, which will not be elaborated here.

Based on the above content, the present application further provides a computer storage medium for storing data generated by a network platform, and a program for processing the data generated by the network platform;
when the program is read and executed by a processor, the relevant content in the embodiment of the method for the interaction of the application service in the cloud desktop, or the relevant content in the embodiment of the method for processing the data of the application service in the cloud desktop, or the relevant content in the embodiment of the method for controlling the application service in the desktop is executed, which will not be expanded here.

Based on the content above, the present application further provides an electronic device, as shown in FIG. 11. FIG. 11 is a schematic structural diagram of an embodiment of an electronic device provided by the present application. The electronic device embodiment can include:
a processor 1101;
a memory 1102, configured to store a program for processing data generated by a network platform, and when the program is read and executed by the processor 1101, the relevant content in the embodiment of the method for the interaction of the application service in the cloud desktop, or the relevant content in the embodiment of the method for processing the data of the application service in the cloud desktop, or the relevant content in the embodiment of the method for controlling the application service in the cloud desktop is executed, which will not be expanded here.

In a typical configuration, a computing device includes one or more processors (CPU), an input/output interface, a network interface, and a memory.

The memory may include non-permanent storage in a computer-readable medium, in the form of random access memory (RAM) and/or non-volatile memory, such as a read-only memory (ROM) or a flash memory (flash RAM). The memory is an example of a computer-readable medium.
1. Computer-readable medium includes permanent and non-permanent, removable and non-removable medium that can achieve information storage by any methods or technologies. The information may be computer-readable instruction(s), data structure(s), program module(s) or other data. Examples of a computer storage medium include, but are not limited to, a phase-change memory (PRAM), a static random access memory (SRAM), a dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disk (DVD) or other optical storage, magnetic cassettes, magnetic tape, magnetic disk storage or other magnetic storage devices, or any other non-transmission medium, which can be used to store information that can be accessed by a computing device. According to the definition in this article, the computer-readable media do not include transitory computer-readable media (transitory media) such as modulated data signals and carrier waves.
2. Those skilled in the art should understand that the embodiments of the present application can be provided as methods, systems or computer program products. Therefore, the present application can take the form of an entirely hardware embodiment, an entirely software embodiment, or an embodiment combining software and hardware aspects. Moreover, the present application can take the form of a computer program product implemented on one or more computer-usable storage media (including but not limited to disk storage, CD-ROM, optical storage, etc.) containing therein computer-usable program codes.

Although the present application is disclosed as above in the form of preferred embodiments, it is not intended to limit the present application. Those skilled in the art can make possible changes and modifications without departing from the spirit and scope of the present application. Therefore, the protection scope of the present application shall be based on the scope defined by the claims of the present application.

1. A method for interaction of an application service in a cloud desktop, comprising:
determining, by an application control service deployed in a client based on a connection relationship established between the client and a cloud desktop server and in response to triggering the application service in the cloud desktop in the client, whether the application service is a cloud application;
if the application service is a cloud application, sending, by the application control service, a start request for the cloud application to a cloud application server;
sending, by the cloud application server according to the start request, application streaming data generated after streaming processing of the cloud application to the application control service; and
outputting, by the client according to the application streaming data received in the application control service, the cloud application into the cloud desktop.

2. The method for interaction of the application service in the cloud desktop according to claim 1, further comprising:
determining, by the application control service when determining that the application service is a local application of the cloud desktop or a local application of the client, whether there is a started cloud application in the cloud desktop;
if there is a started cloud application in the cloud desktop, sending, by the application control service, a streaming request for the started cloud application to the cloud application server;
sending, by the cloud application server according to the streaming request, application streaming data generated after streaming processing of the started cloud application to the cloud desktop server;
performing, by the cloud desktop server according to the application streaming data for the started cloud application, display processing for a picture of the started cloud application in the cloud desktop.

3. The method for interaction of the application service in the cloud desktop according to claim 2, wherein the performing, by the cloud desktop server according to the application streaming data for the started cloud application, display processing for the picture of the started cloud application in the cloud desktop comprises:
placing, by the cloud desktop server according to the application streaming data for the started cloud application, the picture of the started cloud application in the cloud desktop to a lower layer to the local application of the cloud desktop or the local application of the client; or placing the picture of the started cloud application in a form of an icon into a status bar of the cloud desktop.

4. A method for processing data of an application service in a cloud desktop, performed by an application control service deployed in a client, comprising:
determining, based on a connection relationship established between the client and a cloud desktop server and in response to triggering the application service in the cloud desktop in the client, whether the application service is a cloud application;
if the application service is a cloud application, sending a start request for the cloud application to a cloud application server, wherein the start request comprises a streaming processing instruction and streaming data routing information;
receiving application streaming data generated according to the streaming processing instruction and sent in response to the streaming data routing information in the start request.

5. The method for processing the data of the application service in the cloud desktop according to claim 4, further comprising:
determining whether there is a started cloud application in the cloud desktop, when it is determined that the application service is a local application of the cloud desktop or a local application of the client;
if there is a started cloud application in the cloud desktop, sending a streaming request for the started cloud application to the cloud application server, wherein the streaming request comprises streaming processing instruction information and streaming data routing information.

6. A method for controlling an application service in a cloud desktop, performed by a cloud application server, comprising:
receiving a start request for a to-be-started cloud application or a streaming request for a started cloud application; wherein the start request comprises a streaming processing instruction and streaming routing information for the to-be-started cloud application, and the streaming request comprises a streaming processing instruction and streaming routing information for the started cloud application;
performing, according to the streaming processing instruction in the start request, streaming processing for the to-be-started cloud application to generate application streaming data for the to-be-started cloud application; or, performing, according to the streaming processing instruction in the streaming request, streaming processing for the started cloud application to generate application streaming data for the started cloud application;
sending, according to a routing path specified through the streaming routing information in the start request, the application streaming data for the to-be-started cloud application; or, sending, according to a routing path specified through the streaming routing information in the streaming request, the application streaming data for the started cloud application.

7. The method for controlling the application service in the cloud desktop according to claim 6,
wherein the sending, according to the routing path specified through the streaming routing information in the start request, the application streaming data for the to-be-started cloud application comprises:
sending, according to the routing path specified through the streaming routing information in the start request, the application streaming data for the to-be-started cloud application to an application control service-side deployed in the client.

8. The method for controlling the application service in the cloud desktop according to claim 6, wherein the sending, according to the routing path specified through the streaming routing information in the streaming request, the application streaming data for the started cloud application comprises:
sending, according to the routing path specified through the streaming routing information in the streaming request, the application streaming data for the started cloud application to a cloud desktop server.

9-11. (canceled)

12. A computer storage medium for storing data generated by a network platform and a program for processing the data generated by the network platform;
wherein when the program is read and executed by a processor, the processor is enabled to execute the method for processing the data of the application service in the cloud desktop according to claim 4.

13. An electronic device, comprising:
a processor;
a memory for storing a program for processing data generated by a network platform, wherein when the program is read and executed by the processor, the processor is enabled to execute the method for processing the data of the application service in the cloud desktop according to claim 4.

14. The computer storage medium according to claim 12, wherein the processor is further enabled to:
determine whether there is a started cloud application in the cloud desktop, when determining that the application service is a local application of the cloud desktop or a local application of the client;
if there is a started cloud application in the cloud desktop, send a streaming request for the started cloud application to the cloud application server, wherein the streaming request comprises streaming processing instruction information and streaming data routing information.

15. A computer storage medium for storing data generated by a network platform and a program for processing the data generated by the network platform;
wherein when the program is read and executed by a processor, the processor is enabled to execute the method for controlling the application service in the cloud desktop according to claim 6.

16. The computer storage medium according to claim 15, wherein the processor is specifically enabled to:
send, according to the routing path specified through the streaming routing information in the start request, the application streaming data for the to-be-started cloud application to an application control service deployed in the client.

17. The computer storage medium according to claim 15, wherein the processor is specifically enabled to:
send, according to the routing path specified through the streaming routing information in the streaming request, the application streaming data for the started cloud application to a cloud desktop server.

18. The electronic device according to claim 13, wherein the processor is further enabled to:
determine whether there is a started cloud application in the cloud desktop, when determining that the application service is a local application of the cloud desktop or a local application of the client;
if there is a started cloud application in the cloud desktop, send a streaming request for the started cloud application to the cloud application server, wherein the streaming request comprises streaming processing instruction information and streaming data routing information.

19. An electronic device, comprising:
a processor;
a memory for storing a program for processing data generated by a network platform, wherein when the program is read and executed by the processor, the processor is enabled to execute the method for controlling the application service in the cloud desktop according to claim 6.

20. The electronic device according to claim 19, wherein the processor is specifically enabled to:
send, according to the routing path specified through the streaming routing information in the start request, the application streaming data for the to-be-started cloud application to an application control service deployed in the client.

21. The electronic device according to claim 19, wherein the processor is specifically enabled to:
send, according to the routing path specified through the streaming routing information in the streaming request, the application streaming data for the started cloud application to a cloud desktop server.
